(19) United States
(12) Patent Application Publication
(10) Pub. No.: US 2008/0024452 A1
(43) Pub. Date: Jan. 31, 2008

(54) Method Of Data Entry

(75) Inventors: Peter J. Ford, Leyton (GB); Ian Nash, Reading (GB); Ron Bird, Pinner (GB); Alan Wilkinson, London (GB); Lee Cooper, Red House (GB); Adam Johnson, New York, NY (US)

Correspondence Address: FOLEY & LARDNER LLP, P.O. BOX 80278, SAN DIEGO, CA, 92138-0278, US

(73) Assignee: Nokia Corporation

(21) Appl. No.: 10/584,012

(22) PCT Filed: Dec. 21, 2004
(86) PCT No.: PCT/IB04/04228

§ 371 Date: Apr. 12, 2007

(30) Foreign Application Priority Data
Dec. 23, 2003 (GB) 0329860.1

(51) Int. Cl. G06F 3/023

(52) U.S. Cl. 345/169

(57) ABSTRACT

A method for enabling a user to enter data into an electronic device, the method comprising: determining one or more characters as being likely to be selected next by the user; displaying the one or more characters on a display screen of the electronic device as suggested next characters; and providing the user with means for scrolling through the suggested next characters and a plurality of other symbols and selecting one or more of the suggested next characters, or alternatively one or more of the other symbols, as data to be entered into the electronic device.

### FIELD OF THE INVENTION

The present invention relates to data input in electronic devices, and particularly but not exclusively to mobile communications handsets.

### BACKGROUND OF THE INVENTION

It is often necessary for a user of an electronic device, such as a mobile telephone, to input data into the device, for example to enter a telephone number for calling or to enter text to be sent as an SMS (short messaging service) message.

In general, mobile telephone handsets include an ITU-T (International Telecommunication Union Telecommunication Standards) keypad, such as that shown at 1 in FIG. 1. This keypad has a button for each digit from 1 to 0. The buttons 2 to 9 are associated with a group of alphabetic letters. The standard layout is as follows:

2ABC;

3DEF;

4GHI;

5JKL;

6MNO;

7PQRS;

8TUV;

9WXYX.

Optionally, the “1” button can allow a user to input punctuation marks and other symbols, and the “0” button can allow a user to insert a space.

According to one known input method, a user can press a button associated with a number and a group of letters multiple times in order to select one of the letters in the group associated with that button. For example, if a user wishes to enter a letter A, the “2” button should be pressed once. A second press of this button would result in a letter B being input, a third press would result in a C being input, and a fourth press would result in the number 2 being input. Further presses of this button will cause the cycle to be started again, so that a fifth press would result in an A. Consecutive presses of a button must be made within a certain time, such as one second, for the mobile telephone to interpret the multiple presses as intending the group of three or four letters and a number to be cycled through. If a button is pressed once, and the user waits for a delay time longer than, say, one second, and then presses the button again, the mobile device will interpret these presses as intending two characters to be input. For example, if the “2” button is pressed twice, with a four second delay between presses, the device will interpret this as an input of AA.

According to a second known method for entering data into a mobile telephone, known as T9®, or colloquially as “predictive texting”, a single press of a button associated with a group of letters can result in any one of the letters within the group being entered, without the need for multiple presses to denote a second, third or fourth letter in a group. T9® text input simplifies text entry using a standard ITU-T mobile phone keypad. The system uses an electronic dictionary to predict which letter a user is intending to input by a single press of a particular button. As an example, if a user wishes to input the word “meet”, he need only press the following buttons: 6, 3, 3, 8. If T9® is enabled on the user's phone, the software will guess that the word to be entered is “meet” as this can be formed from the letters: “mno”, “def”, “def”, “tuv”.

For certain combinations of buttons, multiple words may correspond to a given sequence of number buttons. If this is the case, T9® will select one of the possible words for displaying on a display screen 3 of a phone, and the user then has the option of scrolling through other alternative words which correspond to the same sequence of buttons.

Other handheld electronic devices, such as personal digital assistants (PDAs), use a full standard “qwerty” keyboard for data entry.

Various problems exist with current ways of inputting data, especially for mobile phones.

Firstly, there is a need for a compromise between the overall size of a handset and the usability of a keypad. It is generally desirable for handsets to be as small as possible to make them more easily portable, but if the keypad comprises very small buttons, then it can be difficult to accurately input data using the buttons. In general, an ITU-T keypad takes up a relatively large proportion of the surface area of a telephone handset.

Secondly, the buttons on a handset generally need to be printed or marked with symbols, icons or alphanumeric characters to indicate the function of a particular button. Many of these markings may need to be different in different marketing regions or in areas using languages with different alphabets. There is therefore a cost involved with producing multiple types of handset for use in different regions.

It is desirable to provide an electronic device with an improved means for entering data in order to overcome the above problems.

### SUMMARY OF THE INVENTION

In accordance with a first aspect of the present invention there is provided a method for enabling a user to enter data into an electronic device, the method comprising: determining one or more characters as being likely to be selected next by the user; displaying the one or more characters on a display screen of the electronic device as suggested next characters; and providing the user with means for scrolling through the suggested next characters and a plurality of other symbols and selecting one or more of the suggested next characters, or alternatively one or more of the other symbols, as data to be entered into the electronic device.

Preferably, the one or more characters or symbols selected by the user are displayed on the display screen.

The determining step may comprise predicting which characters are statistically the most likely to be selected next by the user.

The plurality of other symbols may include one or more icons which are adapted to perform a function on selection by a user.

The scrolling and selecting may be carried out on a handheld electronic device comprising scrolling means and selection means provided by a cylindrical input mechanism. Preferably, scrolling can be achieved by rotating the input mechanism about its axis and selection can be achieved by pushing it along its axis.

The plurality of other symbols may comprise characters grouped as on an ITU-T keypad.

In accordance with a second aspect of the present invention there is provided an electronic device into which a user can enter data, the device comprising: determining means for determining one or more characters as being likely to be selected next by the user when the device is in a data entry mode; a display screen for displaying the one or more characters as suggested next characters; scrolling means allowing the user to scroll through the suggested next characters and a plurality of other symbols; and selection means allowing the user to select one or more of the suggested next characters, or alternatively one or more other symbols, as data to be entered into the electronic device.

In accordance with a third aspect of the present invention there is provided a method of entering data into an electronic device, the device comprising scrolling means and selection means and the method comprising: scrolling, by the scrolling means, through a plurality of groups of symbols, the symbols comprising characters grouped as on an ITU-T keypad, so as to indicate one of the groups; selecting, by the selection means, an indicated group of symbols; selecting one of the symbols of the selected group as data to be entered into the device; and processing the selected symbol as an entered symbol.

The selected symbol may be selected from the selected group by the selection means or alternatively by a character prediction engine.

The plurality of symbols may include one or more icons, and selection of an icon by a user preferably causes the electronic device to perform a function.

The scrolling means and selection means may be provided by a cylindrical input mechanism, whereby scrolling can be achieved by rotating the input mechanism about its axis and selection can be achieved by pushing the input mechanism along its axis.

In accordance with a fourth aspect of the present invention there is provided an electronic device into which a user can enter data, the device comprising: scrolling means for allowing the user to scroll through a plurality of groups of symbols, the symbols comprising characters grouped as on an ITU-T keypad, so as to indicate one of the groups; first selection means for allowing the user to select one of the indicated groups of symbols; second selection means for selecting one of the symbols from the selected group as data to be entered into the device; and processing means for processing the selected symbols as an entered symbol.

The first selection means may be provided by the same mechanism as the first selection means, in which case the second selection means may be provided by a cylindrical input mechanism, or alternatively the second selection means may comprise a character prediction engine.

In accordance with a fifth aspect of the present invention there is provided a method of entering data into an electronic device, the device comprising scrolling means and selection means and the method comprising: scrolling, by the scrolling means, through a plurality of logically arranged groups of symbols, so as to indicate one of the groups; selecting, by the selection means, an indicated group of symbols; and selecting one of the symbols from the selected group as data to be entered into the device.

The method could suitably further comprise the steps of: subsequently determining, by means of a computer program within the device, one or more symbols as being likely to be selected next by a user; and displaying the one or more symbols on a display screen of the electronic device as suggested next symbols. This can enable a fast and user-friendly way of providing text entry.

The groups of logically arranged symbols could be groups of symbols arranged as on an ITU-T keypad. Since users are already be familiar with this arrangement it is a preferred way of grouping symbols.

The groups of symbols or the one or more symbols could include one or more icons which are adapted to perform a function on selection by a user.

In accordance with a sixth aspect of the present invention there is provided an electronic device into which a user can enter data, the device comprising: scrolling means for allowing the user to scroll through a plurality of logically arranged groups of symbols so as to indicate one of the groups; first selection means for allowing the user to select one of the indicated groups of symbols; and second selection means for selecting one of the symbols from the selected group as data to be entered into the device.

The electronic device could further comprise determining means for determining one or more symbols as being likely to be selected next by the user; and a display screen for displaying the one or more symbols as suggested next symbols.

Conveniently, the second selection means could be provided by the same mechanism as the first selection means. The second selection means could comprise a character prediction engine.

### BRIEF DESCRIPTION OF THE DRAWINGS

The invention will now be described by way of example with reference to the accompanying drawings, in which:

FIG. 1 shows a mobile telephone handset having a standard ITU-T keypad;

FIG. 2 shows a handset in accordance with an embodiment of the present invention;

FIG. 3 shows a character strip for display on a display screen of a handset;

FIG. 4 shows further examples of character strips in accordance with embodiments of the invention.

In the drawings, like reference numerals are used to refer to like parts.

### DETAILED DESCRIPTION

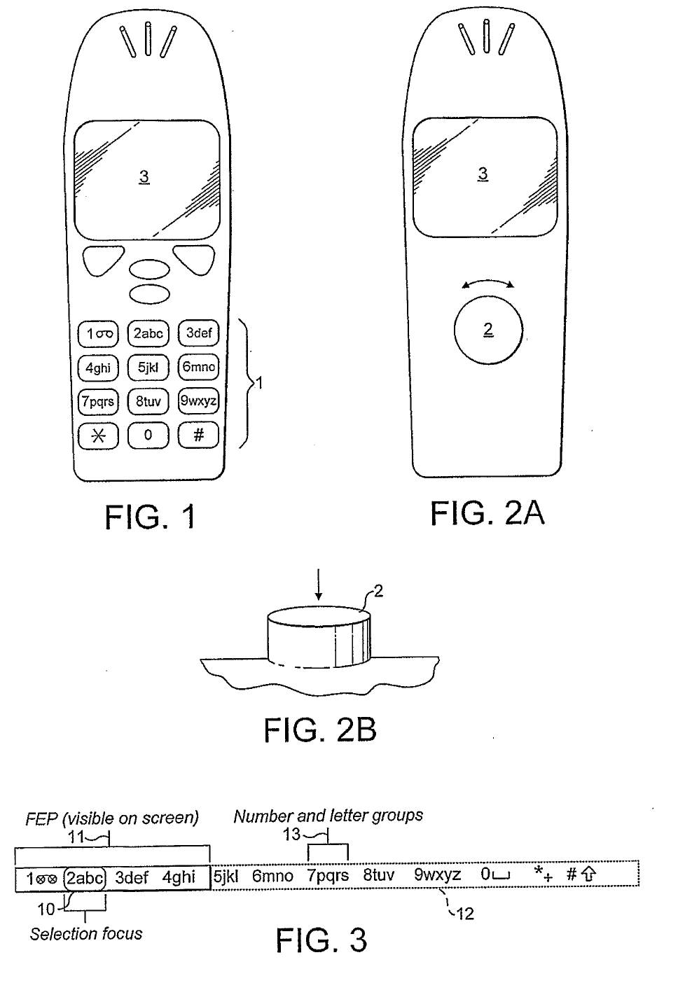

FIG. 2A shows a handset in accordance with an embodiment of the present invention. This handset does not have a standard ITU-T keypad (such as that shown as 1 in FIG. 1), but rather it has a rotator 2 as an input mechanism. Manipulation of the rotator 2 can result in data such as text data being input into the handset and displayed on the display screen 3.

FIG. 2B shows a side view of the rotator input mechanism 2, illustrating that the rotator is a generally cylindrical mechanism which can be pressed downwards, in the direction towards the handset. In general, rotating the rotator 2 about its axis, as indicated in FIG. 2A, causes a plurality of symbols such as alphanumeric characters to be scrolled through, and pressing of the rotator in the direction illustrated in FIG. 2B causes a highlighted symbol, which may for example be a single letter or a group of letters and a number, to be selected.

A convenient way of implementing the data entry mechanism involves the use of a character strip such as that shown in FIG. 3. The length of this strip will typically be wider than the display screen 3 of a mobile handset, and only a portion of the strip will be visible on the screen at a given moment. In FIG. 3, the region 11 is indicated as being visible on the screen at a given moment in time, with the group “2abc” being highlighted at that moment. A user can move the position of the character strip in order to change the highlighted portion 10 by rotating the input mechanism 2 in a clockwise or an anticlockwise direction. Suitably, clockwise movement of the rotator will result in the highlighted portion adjusting to the next set of characters to the right on the character strip (“3def” in the example shown in FIG. 3) and anticlockwise movement will result in the highlighted portion moving to the left.

Preferably a user can choose to scroll more quickly through the character strip by “paging” the strip to the left or right. This can conveniently be achieved by using left or right cursor keys which may be separate from or integral with the rotator 2. In the example shown in FIG. 3, pressing the right cursor key would shift the portion of the character strip that is visible on the display screen 3 to the number and letter groups “5jkl, 6mno, 7pqrs, 8tuv”. By using the rotating function of the rotator 2 a user can then navigate between these groups 13 within that displayed portion.

The example described above relates to the entry of text or number data; however, the number and letter groups 13 shown in FIG. 3 could alternatively be symbols or icons denoting functions to be carried out by the mobile handset. For example, the symbol shown next to the number 1 on the character strip of FIG. 3 denotes a voicemail function. By clicking the rotator while the highlighted portion of the character strip is located above the “1 button”, the voicemail function can be selected by a user. Suitably, a long press of a button can cause a function associated with that button to be implemented while a quick press can cause a character to be entered. This arrangement is known in the field of mobile communication devices.

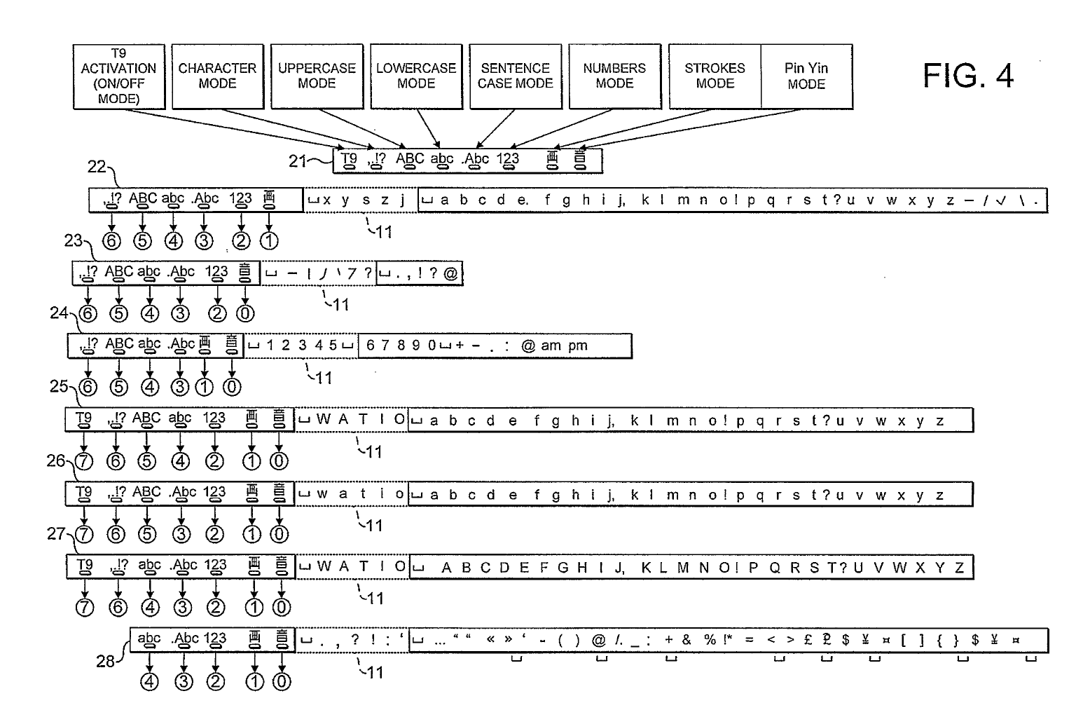

Other functions such as the activation or deactivation of T9® text input or a choice of text input mode could be provided on the character strip. FIG. 4 shows specific embodiments of suitable character strips. The strip 21 includes a series or functions: T9® activation; character mode; uppercase mode; lowercase mode; sentence case mode; numbers mode; strokes mode and pin yin mode. The icons representing each of these functions can be scrolled through in the same way as the groups 13 illustrated in FIG. 3.

In each of character strips 22 to 28, the portion marked 11 represents a portion of the character strip that is visible at a given time on a display screen 3 of a handset.

In one embodiment of the present invention, the displayed portion 11 displays a series of letter characters that are predicted by software within the handset as being likely to be selected by a user. The T9® text input mechanism can be used in conjunction with this embodiment of the present invention to provide a prediction of subsequent letters to be chosen by a user.

Considering in detail character strip 25, the displayed portion 11 displays five letters. For the following discussion, it can be assumed that a user is beginning to enter a text message into a mobile phone handset. Appropriate software in the handset determines that one of the five letters WATIO is statistically most likely to be input by a user at the start of a sentence. These five letters are therefore displayed in the portion 11 so that the user can easily select one of these five letters for the first letter of the message. Conveniently, one of the five letters can be highlighted initially and, by rotating the rotator 2, the user can move the position of the highlighting to coincide with a letter he wishes to enter. His desired letter may be one of the five displayed letters shown in portion 11, or alternatively he may wish to enter some other character that is not shown in the portion 11. In that case, the user can scroll, either by means of rotating the rotator or by use of the paging function described above, beyond the five currently displayed letters and into the right hand portion of the character strip which contains all the letters of the Latin alphabet. Letters within this right-hand portion will sequentially be displayed as the user scrolls through them.

Once the highlighted portion coincides with a letter which the user wishes to enter, he can select that letter by pressing the rotator 2.

After a letter has been entered, and if a space character is not subsequently entered, a T9® engine, or any other dictionary-based character prediction engine, can determine which letter or letters is or are most likely to be selected next by the user. For example, if a T is entered at the start of a word, the most likely next letter might be an H, and this could be shown as the first of, say, five letters to be displayed in the portion 11. Then, when a user is to enter the second letter of the word, he can choose one of the five displayed letters 11 or any other letter from the right-hand portion of the character strip 25 in FIG. 4. Suitably, the digits 1 to 0 could be selected by scrolling beyond the letter characters, or alternatively a numerical data entry mode could be selected (24) by scrolling left from the displayed portion 11 until the mode icon marked as 2 in FIG. 4 is highlighted and subsequently selected.

By displaying first the most likely next characters, the speed of data entry can be increased.

It was noted above that the symbol marked 2 in the character strip 25 of FIG. 4 denotes a numerical data entry mode. In each of character strips 22-28, the portion shown to the left of the displayed portion 11 shows a series of symbols which can be selected to perform a function. In the examples shown in FIG. 4, each of the functions represents a type of data entry mode. 0 represents pin yin mode; 1 represents strokes mode; 2 represents numbers mode; 3 represents sentence case mode; 4 represents lowercase mode; 5 represents uppercase mode; 6 represents punctuation character mode and 7 represents T9® on/off mode. Functions could also be made available for selection to allow a user to select a language for text data entry to enable T9® to operate for that language.

Character strip 28 is in character mode, and thus the modes labelled 6 and 7 are not included in the left-hand portion of the character strip. (T9® is only effective for the Latin alphabet).

Character strip 22 is shown in pin yin mode, and therefore mode 0 is not available to be selected. Character strip 23 is shown in strokes mode, and modes 1 and 7 are not shown in the left-hand portion of the character strip as these are not active modes. Strip 24 is in numbers mode and modes 2 and 7 are not shown. Strips 25 to 27 are in sentence case mode, lowercase mode and uppercase mode respectively. The corresponding mode symbols are not shown in the character strips.

Preferably, once a character has been selected for input by a user that character is displayed in a portion of a display screen 3 of a handset. In this way, a message can be built up by the selection of a sequence of characters including punctuation marks, space characters and numerical characters as well as alphabetic characters.

Embodiments of the present invention are applicable to any kind of data entry that may be desired by a user. For example, the character strips and/or the rotator mechanism 2 can be used for entering a text message, entering a phone number to be dialled, selecting a mode of the handset such as, for example, silent mode, or even for changing settings of the handset such as the clock or the ring tone. The display 3 of the handset could adapt accordingly to allow a user to navigate menus and choose modes or functions. It can therefore be seen that the use of an input mechanism such as the rotator 2 or a set of cursors can preclude the need for a standard ITU-T keypad, thus overcoming the problems discussed above.

In a particularly preferred embodiment of the invention, the face of a mobile communication handset, including the input mechanism, need not be marked in any way with symbols or characters, and in particular it need not be marked with characters which would need to be different depending on the geographic region in which the handset is intended to be used. This overcomes a further problem discussed above.

In one embodiment of the invention, the rotator 2 could be adapted in such a way that any given letter character is associated with a particular orientation of the rotator. This can further facilitate text data entry since a user can become accustomed to a particular position of the rotator representing a particular letter and the speed of data entry can therefore further be increased. In one specific embodiment, a full rotation of the rotator 2 could be divided into 360/N positions, where N is the number of letters, numbers or other symbols such as punctuation marks or mode functions to be available to a user when the handset is in a particular operating mode. In the example of text data entry, the rotator could be assigned 30 distinct positions, where each of those 30 positions represents one letter of the alphabet or one punctuation mark from a group including, say, full stop, comma, question mark and exclamation mark. In this way, a user would get to know that a certain orientation of the rotator would be required for entering a certain letter or symbol. In this specific embodiment, it may be convenient to mark a surface of the rotator 2 so that the orientation of the rotator can be determined quickly on inspection of the rotator alone.

One preferred embodiment of the invention uses a combination of symbol grouping and next-character prediction. In an example of this type of embodiment, when a user enters a text entry mode on a mobile phone, he is presented with logically-grouped symbols (for example an ITU-T arrangement), and these groups can be scrolled through for the entry of a first character. When a group is chosen, a character within that group can be selected for entry into the phone. After this first character has been entered, the display of the phone changes to show a series of suggested next characters, which have been identified as being statistically the most likely characters to be entered next.

A further aspect of this embodiment, which could be applied to any of the embodiments described herein, involves including within the series of suggested next symbols one or more icons which when selected cause a function to be carried out. For example, an icon could relate to sending a message which has been entered using the methods described above. In a particular example, when a complete sentence has been entered into the device, recognized by the device by the use of a full stop, a predetermined list of icons could be presented to the user, including a space function and a series of options for sending the message, for example SMS; MMS; or email. In this way, a message can very conveniently be sent by a user. When the complete message has been entered, the device senses that a full stop has just been entered and responds by displaying a “SEND” icon, or a series of specific icons such as “SEND SMS”, “SEND MMS”, or “SEND EMAIL”. When one of these is selected, the user could then be taken to his contacts list to select a person for sending the message to.

The arrangement described above can be more convenient than previous arrangements in which a user had to decide before entering text which type of message was to be sent.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. A method for enabling a user to enter data into an electronic device, the method comprising:
determining one or more characters as being likely to be selected next by the user;
displaying the one or more characters on a display screen of the electronic device as suggested next characters; and
providing the user with means for scrolling through the suggested next characters and a plurality of other symbols and selecting one or more of the suggested next characters, or alternatively one or more of the other symbols, as data to be entered into the electronic device.

2. A method according to claim 1 wherein the one or more characters or symbols selected by the user are displayed on the display screen.

3. A method according to claim 1 or claim 2 wherein the determining step comprises predicting which characters are statistically the most likely to be selected next by the user.

4. A method according to any preceding claim wherein the plurality of other symbols includes one or more icons which are adapted to perform a function on selection by a user.

5. A method according to any preceding claim wherein the scrolling and selecting steps are carried out on a handheld electronic device comprising scrolling means and selection means, wherein the scrolling means and the selection means are provided by a cylindrical input mechanism, and scrolling can be achieved by rotating the input mechanism about its axis and selection can be achieved by pushing the input mechanism along its axis.

6. A method according to any preceding claim wherein the plurality of other symbols comprises characters grouped as on an ITU-T keypad.

7. An electronic device into which a user can enter data, the device comprising:
determining means for determining one or more characters as being likely to be selected next by the user when the device is in a data entry mode;
a display screen for displaying the one or more characters as suggested next characters;
scrolling means allowing the user to scroll through the suggested next characters and a plurality of other symbols; and
selection means allowing the user to select one or more of the suggested next characters, or alternatively one or more other symbols, as data to be entered into the electronic device.

8. An electronic device according to claim 7 wherein the one or more characters or symbols selected by the user are displayed on the display screen.

9. An electronic device according to claim 7 or claim 8 wherein the determining means is adapted to predict which characters are statistically the most likely to be selected next by the user and to identify these characters as the suggested next characters.

10. An electronic device according to any of claims 7 to 9 wherein the plurality of other symbols includes one or more icons which are adapted to perform a function on selection by a user.

11. An electronic device according to any of claims 7 to 10 wherein the scrolling means and the selection means are provided by a cylindrical input mechanism, and scrolling can be achieved by rotating the input mechanism about its axis and selection can be achieved by pushing the input mechanism along its axis.

12. An electronic device according to any of claims 7 to 11 wherein the plurality of other symbols comprises characters grouped as on an ITU-T keypad.

13. A method of entering data into an electronic device, the device comprising scrolling means and selection means and the method comprising:
scrolling, by the scrolling means, through a plurality of groups of symbols, the symbols comprising characters grouped as on an ITU-T keypad, so as to indicate one of the groups;
selecting, by the selection means, an indicated group of symbols;
selecting one of the symbols of the selected group as data to be entered into the device; and
processing the selected symbol as an entered symbol.

14. A method according to claim 13 wherein the selected symbol is selected from the selected group by the selection means.

15. A method according to claim 13 wherein the selected symbol is selected from the selected group by a character prediction engine.

16. A method according to any of claims 13 to 15 wherein the plurality of symbols includes one or more icons, the electronic device being adapted to perform a function on selection of an icon by a user.

17. A method according to any of claims 13 to 16 wherein the scrolling means and the selection means are provided by a cylindrical input mechanism, and scrolling can be achieved by rotating the input mechanism about its axis and selection can be achieved by pushing the input mechanism along its axis.

18. An electronic device into which a user can enter data, the device comprising:
scrolling means for allowing the user to scroll through a plurality of groups of symbols, the symbols comprising characters grouped as on an ITU-T keypad, so as to indicate one of the groups;
first selection means for allowing the user to select one of the indicated groups of symbols;
second selection means for selecting one of the symbols from the selected group as data to be entered into the device; and
processing means for processing the selected symbols as an entered symbol.

19. An electronic device according to claim 18 wherein the second selection means is provided by the same mechanism as the first selection means.

20. An electronic device according to claim 18 wherein the second selection means comprises a character prediction engine.

21. An electronic device according to any of claims 18 to 20 wherein the plurality of symbols includes one or more icons and the device is adapted to perform a function on selection of an item by the user.

22. An electronic device according to any of claims 18 to 21 wherein the scrolling means and the first selection means are provided by a cylindrical input mechanism, and scrolling can be achieved by rotating the input mechanism about its axis and selection can be achieved by pushing the input mechanism along its axis.

23. An electronic device according to claim 22 wherein the second selection means is provided by the cylindrical input mechanism.

24. A method of entering data into an electronic device, the device comprising scrolling means and selection means and the method comprising:
scrolling, by the scrolling means, through a plurality of logically arranged groups of symbols, so as to indicate one of the groups;
selecting, by the selection means, an indicated group of symbols; and
selecting one of the symbols from the selected group as data to be entered into the device.

25. A method according to claim 24 further comprising the steps of:
subsequently determining, by means of a computer program within the device, one or more symbols as being likely to be selected next by a user; and
displaying the one or more symbols on a display screen of the electronic device as suggested next symbols.

26. A method according to claim 24 or claim 25 wherein the groups of logically arranged symbols are groups of symbols arranged as on an ITU-T keypad.

27. A method according to any of claims 24 to 26 wherein the groups of symbols or the one or more symbols include one or more icons which are adapted to perform a function on selection by a user.

28. An electronic device into which a user can enter data, the device comprising:
scrolling means for allowing the user to scroll through a plurality of logically arranged groups of symbols so as to indicate one of the groups;
first selection means for allowing the user to select one of the indicated groups of symbols; and
second selection means for selecting one of the symbols from the selected group as data to be entered into the device.

29. An electronic device according to claim 28 further comprising:
determining means for determining one or more symbols as being likely to be selected next by the user; and
a display screen for displaying the one or more symbols as suggested next symbols.

30. An electronic device according to claim 28 or claim 29 wherein the groups of logically arranged symbols are arranged as on an ITU-T keypad.

31. An electronic device according to any of claims 28 to 30 wherein the second selection means is provided by the same mechanism as the first selection means.

32. An electronic device according to any of claims 28 to 30 wherein the second selection means comprises a character prediction engine.

33. An electronic device according to any of claims 28 to 32 wherein the groups of symbols or the one or more symbols include one or more icons which are adapted to perform a function on selection by a user.
